(19) United States
(12) Patent Application Publication
(10) Pub. No.: US 2003/0112239 A1
(43) Pub. Date: Jun. 19, 2003

(54) Method of mesh simplification via ununiform spatial division

(76) Inventors: Chang Min Shin, Seoul (KR); Seung Min Park, Taejon (KR); Chae Kyu Kim, Taejon (KR)

Correspondence Address: JACOBSON, PRICE, HOLMAN & STERN, PROFESSIONAL LIMITED LIABILITY COMPANY, 400 Seventh Street, N.W, Washington, DC, 20004, US

(21) Appl. No.: 10/067,389

(22) Filed: Feb. 7, 2002

(30) Foreign Application Priority Data
Dec. 18, 2001 (KR) 2001 - 80721

(51) Int. Cl. G06T 15/30; G06T 17/20; G06T 17/00

(52) U.S. Cl. 345/428; 345/423

(57) ABSTRACT

The invention relates to a method of mesh simplification via ununiform spatial division. The curvatures of vertices are obtained, and a space surrounding meshes is ununiformly divided and a curvature tree is produced using the curvatures. In the curvature tree, the curvatures of the vertices decrease as nodes have lower hierarchies. Simplification is executed from lower nodes to higher nodes to primarily remove those vertices having smaller effects to the mesh transformation, thereby hardly large effects to the original mesh shape. Therefore, the invention ununiformly divides the space according to the curvatures so as to primarily simplify those vertices having substantially no effects to the transformation of the original meshes, thereby more excellently maintaining characteristic parts of the meshes while achieving a high execution rate.

### BACKGROUND OF THE INVENTION

1. Field of the Invention

The present invention relates to a method of mesh simplification via ununiform spatial division. In particular, method of mesh simplification via ununiform spatial division of the invention ununiformly divides a space in the order of curvature to primarily simplify vertices having smaller effects to transformation of an original meshes, thereby maintaining characteristic parts of the meshes more excellently together with a high execution speed.

2. Description of the Related Art

The interactive three-dimensional computer graphics industry generally use mesh models composed of several millions of polygons. However, most hardware can hardly render millions of geometric data in real-time.

In order to overcome such a problem, various methods are proposed including a visibility determination, texture mapping, mesh simplification and the like.

The mesh simplification removes geometric information of meshes such as vertices while maintaining the topology and sharp edges of the meshes created using a CAD, range scanner and the like so as to produce simplified meshes, which look as the same as the initial meshes to people.

The mesh simplification includes a Decimation method, by which vertices are removed from meshes and the meshes are reconstructed. The decimation method comprises: classifying the vertices on a given basis to select at least one vertex to be removed; removing the selected vertex to remove all triangles connected to the vertex; and applying a triangulation algorithm to a hole produced by removing the vertex. The foregoing processes are repeated.

A simplification algorithm of Schroeder is representative as the decimation method. This method is costly in applying the triangulation algorithm, and has drawbacks in a multi-resolution rendering system. Further, since meshes are simplified while maintaining local topology without consideration of global topology, the quality of the simplified meshes is degraded.

An edge contraction reduces geometric data of meshes using a simple operation of interconnecting two vertices connecting an edge into one vertex. Therefore, the triangulation algorithm is not applied as in the decimation method.

The edge contraction is used by Gueziec, Hoppe, Garland and so on, and also called as Edge collapse. Algorithms used in the edge contraction are different in selection of candidate edges to be simplified. However, using the edge contraction may occasionally change the orientations of faces which are produced posterior to edge contraction. In general, a simplification process is not carried out in this case. The face produced posterior to edge contraction may have a poor aspect ratio. Simplification is not carried out also in this case, whereas Gueziec improved the aspect ratio of face using a concept of compactness.

Since a shorter edge has a smaller effect to the mesh shape than a larger edge, most edge simplification algorithms primarily simplify a shorter one, found through search. Further, every simplification algorithm has a different method for positioning new resultant vertices posterior to edge contraction.

The Hierarchical Dynamic Simplification (HDS) algorithm of Luebke is representative as a vertex clustering method, in which a bounding box created for covering initial meshes is divided into a predetermined interval. Then, a vertex tree is produced, in which each node of the vertex tree sets a vertex having the largest curvature of vertices in the node as the representative vertex. The vertex tree can be obtained using the geometric information of simplified meshes which are produced in a simplification process as the representative vertices.

Therefore, this method has a high simplification rate. However, the vertices having smaller effects to the mesh shape are occasionally simplified posterior to those vertices having larger effects to the mesh shape, thereby degrading the quality of the meshes.

The HDS algorithm of Luebke of the vertex clustering method uses curvatures in setting the representative vertices, in which those vertices having the larger effects to the mesh shape are occasionally removed beforehand caused by uniform spatial division.

Although this method is executed so fast to support real-time simplification, a disadvantage occurs that the meshes produced through simplification have poor quality.

### SUMMARY OF THE INVENTION

The inventive algorithm primarily obtains the curvature at each of vertices in meshes, and the vertices are arranged in the order of curvature using the obtained curvatures. Instead of uniform spatial division in the order of the arranged vertices, a space repeatedly undergoes ununiform division on the basis of vertex positions to produce a curvature tree.

A vertex having the largest effect to the shape of meshes is positioned in the root node of a curvature tree, and divided into eight lower nodes again. As nodes have lower hierarchies, vertices positioned therein have smaller effects to the mesh shape. Substantial simplification is executed via edge contraction of mesh geometric information in the nodes having curvatures which are smaller than a curvature predetermined by a user, in which edges are repeatedly contracted from lower nodes up to higher nodes in the just above hierarchy. Therefore, the simplified meshes maintain similar shapes to the initial meshes while maintaining a high simplification rate as in a conventional uniform spatial division.

As the vertex clustering method, the present invention divides a space using previously calculated curvatures of vertices, in which those vertices having larger effects to the mesh shape are primarily used to divide the space and those vertices having smaller effects to the mesh shape are used later to divide the previously divided space. Therefore, those vertices having smaller curvatures are positioned in lower nodes of a resultant curvature tree. Further, simplification is executed from lower nodes of the curvature tree to higher nodes.

The simplification as above primarily removes the vertices having the smaller curvatures to maintain the shape of the simplified meshes similar to that of the initial meshes, thereby avoiding the disadvantage of the vertex clustering. Further, geometric data to be removed are previously determined in the curvature tree, thereby enabling a high execution rate. However, the invention is rather slower than the vertex clustering because the inventive algorithm does not obtain the geometric information of the simplified meshes using the representative vertices.

The inventive algorithm uses edge contraction to remove the geometric data. Candidate edges for contraction are more rapidly searched in the invention because the candidate edges are restricted into those edges in the nodes which are searched using the curvature tree.

The decimation method considers the local geometry having no consideration for the global geometry. However, since the space is divided using the curvatures, the invention considers both of the global geometry and the local geometry, thereby improving the quality of the simplified meshes. The global geometry is used because removal priorities of the total geometric data of the meshes are determined using cells as units, and the local geometry is used because removal priorities of the geometric data are determined in the cells.

Therefore, the invention are characteristic of: using edge contraction which is free from triangulation problems to remove the geometric data at a low cost; using the curvature tree to rapidly search for candidate edges ensuring a high-speed spatial division; and performing ununiform spatial division in consideration of the curvatures to obtain the simplified mesh shape similar to the initial one.

Further, the invention uses the curvatures as the weights of the vertices to maintain the curvatures of the initial meshes after simplification, thereby providing an algorithm adequate to models such as atom and molecule models in chemistries, in which the curvatures are heavily changed and thus curvature preservation is critical. Also, the curvature tree has a static structure which can restore the simplified meshes to the original meshes.

According to an aspect of the invention to obtain the foregoing objects, a method of mesh simplification via ununiform spatial division comprises the following steps of: calculating curvatures of all vertices composing a mesh; arranging the vertices in the order of curvature using the calculated curvatures of the vertices to produce a vertex weight list; producing a curvature tree while dividing a space using the resultant vertex weight list; searching for a plurality of object cells for simplification in the resultant curvature tree, and searching for candidate edges for simplification having smaller effects to the shape of the mesh from the searched object cells for simplification; and contracting the searched edges in sequence.

In the method of mesh simplification via ununiform spatial division according to the invention, said candidate edge searching step comprises the steps of: aspect ratio test for determining the order of the edges to be contracted using contraction; boundary test for judging whether an edge exists in a boundary after said step of aspect ratio test, and selecting the edge as to be contracted if the edge does not exist in the boundary; manifold test for confirming whether a non-manifold is produced after edge contraction, and selecting the edge as to be contracted only if the non-manifold is not produced; orientation test for judging whether faces which are produced after edge contraction have variation of orientation, and determining the edge as to be contracted only if there is no variation of orientation; and calculating the angle between the faces which are produced after edge contraction, and determining the edge as a candidate edge to be contracted if the angle is within a value predetermined by a user.

In the method of mesh simplification via ununiform spatial division according to the invention, said contracting step uses an edge contraction in which a plurality of vertices composing the edge are mutually connected.

In the method of mesh simplification via ununiform spatial division according to the invention, the vertices of the curvature tree have smaller curvatures in lower nodes, and said calculating step uses a method of curvature calculation by Turk.

In the method of mesh simplification via ununiform spatial division according to the invention, said method of curvature calculation by Turk comprises the steps of: (a) creating a root node of the curvature tree using the first vertex in the curvature weight list as a representative vertex, and producing a plurality of lower nodes on the basis of the position of the representative vertex; (b) selecting the second vertex in the vertex weight list, and after finding out to which node the second vertex belongs in the lower nodes of the previously created root node, producing lower nodes using the second vertex as the representative vertex; and repeating the foregoing steps (a) and (b) for all of the remaining vertices.

According to another aspect of the invention to obtain the foregoing objects, a method of mesh simplification via ununiform spatial division comprises the following steps of: calculating curvatures of all vertices composing a mesh; arranging the vertices in the order of curvature using the calculated curvatures of the vertices to produce a vertex weight list; producing a curvature tree while dividing a space using the produced vertex weight list; searching for an object node for simplification from a root node of the resultant curvature tree; searching an arbitrary number of lower nodes in the object node for search; judging whether a node value is null in the lower nodes, sequentially from the lowest node up to the highest node, and if the node value is null, judging whether a curvature value of a representative vertex in the object node for search is at least a constant value predetermined by a user; and if the curvature value of the representative vertex in the object node for search is at least constant value predetermined by a user, selecting the object node for search as the object node for simplification.

According to still another aspect of the invention to obtain the foregoing objects, a method of mesh simplification via ununiform spatial division comprises the following steps of: (a) calculating curvatures of all vertices composing a mesh; (b) arranging the vertices in the order of curvature using the calculated curvatures of the vertices to produce a vertex weight list; (c) producing a curvature tree while dividing a space using the produced vertex weight list; (d) searching a plurality of nodes to be simplified in a root node of the resultant curvature tree, and comparing a curvature value of a representative vertex of each of the searched nodes with a constant predetermined by a user to select an object node for simplification; (e) extracting a boundary flag value of the object node for simplification, and removing geometric data using an edge contraction method based upon the extracted boundary flag value; and (f) repeating the foregoing steps (a) to (e) by increasing the flag value of the object node for simplification by +1 to remove the geometric data.

### BRIEF DESCRIPTION OF THE DRAWINGS

In the following drawings:

FIG. 1 shows an algorithm structure for a method of mesh simplification via ununiform spatial division of the invention;

FIG. 2 is a structure illustrating components of a curvature tree;

FIG. 3 shows an example of a curvature tree;

FIG. 4 shows an example of simplification process of a curvature tree;

FIG. 5 is a flow chart illustrating a method of searching for object nodes for simplification according to a method of mesh simplification via ununiform spatial division of the invention;

FIG. 6 is a flow chart illustrating a method of mesh simplification via ununiform spatial division of the invention; and

FIG. 7 shows an example of result obtained according to a method of mesh simplification via ununiform spatial division of the invention.

### DETAILED DESCRIPTION OF THE PREFERRED EMBODIMENT

The following detailed description will present a preferred embodiment according to a method of mesh simplification via ununiform spatial division of the invention in reference to the accompanying drawings.

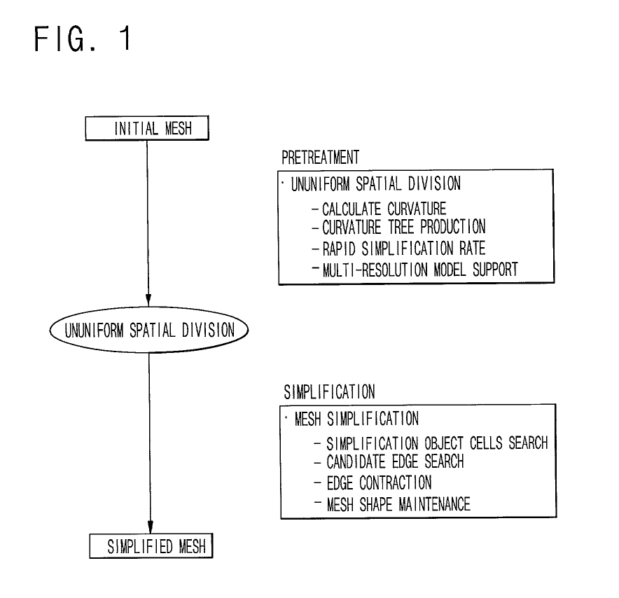

FIG. 1 shows an algorithm structure according to the method of mesh simplification via ununiform spatial division of the invention, in which the mesh simplification is generally divided into an ununiform spatial subdivision stage and a simplification stage.

As shown in FIG. 1, application of ununiform spatial division into initial meshes divides the meshes and generates a curvature tree. A simplification algorithm is applied to the spatially divided meshes to generate simplified meshes.

The first stage, i.e. the ununiform spatial division stage, primarily calculates curvatures of all vertices composing the meshes. The resultant curvatures are defined as weights of the vertices, and all of the vertices are arranged based upon the weights to create a vertex weight list.

The initial mesh is spatially divided using the first vertex in the vertex weight list and then again using the second vertex in the vertex weight list. Such a process is repeated until all of the vertices in the vertex weight list are used. The spatial division in this case is carried out using an octree algorithm as a conventional vertex clustering.

A spatial division used in the conventional vertex clustering makes the smallest bounding box for surrounding the mesh, and using the octree algorithm, divides the same into a predetermined interval. Therefore, cells in the same level have the same size in the resultant tree.

According to the invention, however, cells in the same level have different sizes from one another in the resultant tree because the spatial division is carried out on the basis of the positions of the vertices. Such a spatial division for producing the cells into different sizes is called the ununiform spatial division.

The curvature tree produced via the ununiform spatial division has a static and hierarchical structure. Due to the static structure, this curvature tree can return to the initial meshes again after simplification of the meshes.

Since the space is divided by ranking the vertices according to the weights, those vertices with small values of curvature are positioned in lower nodes of the resultant curvature tree while those vertices with large values of curvatures are positioned in higher nodes of the tree.

The second stage is the simplification stage. Geometric data are eliminated from the meshes using an edge contraction method, which removes the necessity of triangulation. The edge contraction connects between two vertices composing an edge. Simplification is carried out using each cell as one unit, primarily in lower nodes of the curvature tree and then in higher nodes.

Since vertices having smaller curvatures are positioned in lower nodes in the curvature tree, those vertices having smaller effects to the mesh shape are primarily removed. Therefore, the shape of the simplified meshes is not quite different from that of the initial meshes.

In the invention, the curvature is calculated using a method of curvature calculation by Turk. The curvature at an arbitrary point is expressed with the radius of the largest globe at one side of the face which is more bent. The curvature is calculated using an approximation method.

By using the calculated curvatures, the vertices are arranged according to their order of curvature to produce a vertex weight list. The space is divided based upon the vertex weight list, producing the curvature tree. The space is divided as follows: The root node of the curvature tree is created using the first vertex in the vertex weight list as a representative vertex, and the first eight lower nodes thereof are produced on the basis of the position of the representative vertex.

The second vertex is selected from the vertex weight list, and after finding out to which node the second vertex belongs in the first eight lower nodes, second eight lower nodes are produced using the second vertex as the representative vertex of the found one of the first eight lower nodes. This process is applied to all elements of the vertex weight list.

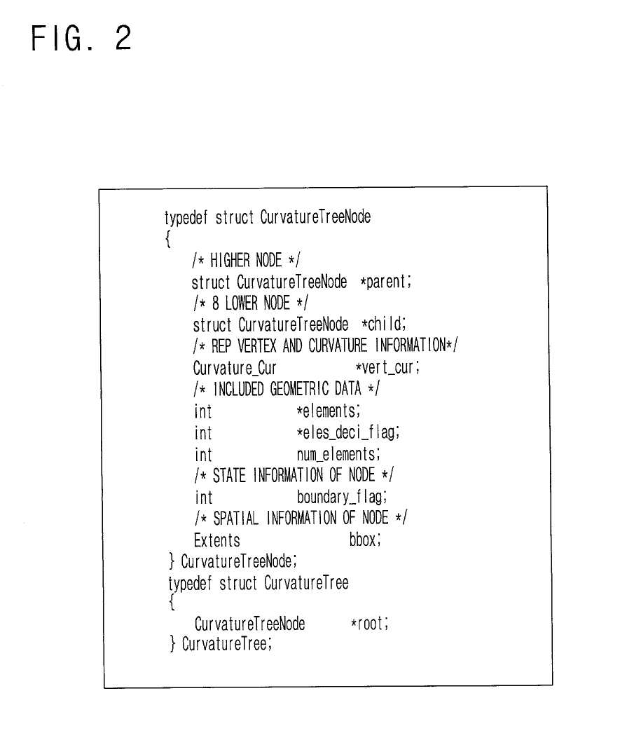

FIG. 2 is a structure illustrating components of the curvature tree.

A boundary flag of the curvature tree has an integer value from −1 to 8 as a variable for indicating the number of the lower nodes in the just below hierarchy in which mesh information is simplified. For example, a boundary flag value of −1 indicates that there are no simplified lower nodes, 5 indicates that there are six simplified lower nodes, and 8 indicates that its own node is simplified.

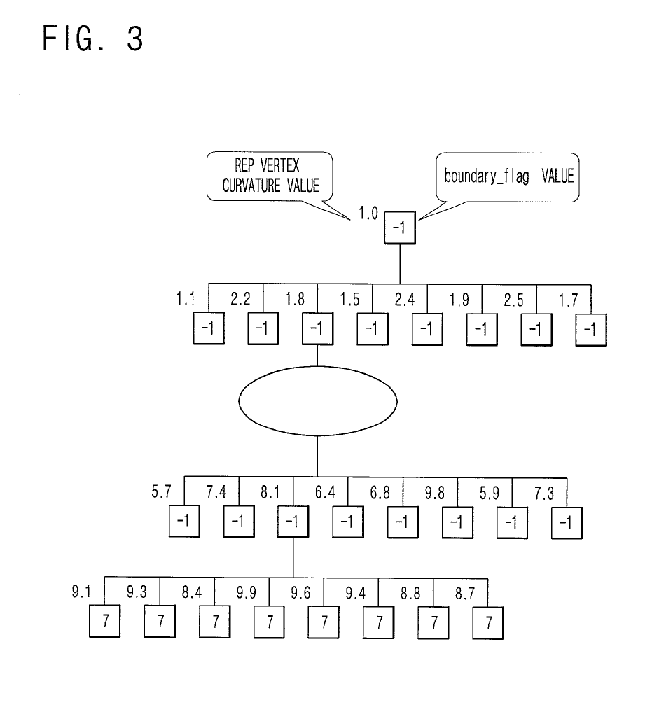

FIG. 3 shows an example of curvature tree which is not simplified yet after spatial division, in which the number of each node indicates the boundary flag value of the node. A variable element has an index of vertexes that its node has, and a variable bbox indicates the size of the node.

If no vertex exists in each cell of the curvature tree, no representative vertex exists in the cell. If one vertex exists, the vertex is the representative vertex of the cell. If the cell has two vertices or more, the vertex with the largest curvature is used as the representative vertex. The lowest node of the curvature tree, which is produced via spatial division by selecting the vertices from the vertex weight list, only has at least one vertex located therein.

The curvature tree has a static structure allowing the curvature tree to maintain the geometric data information even after simplification. Therefore, it is possible to restore the simplified meshes into the original meshes.

The invention executes hierarchical simplification using the curvature tree via ununiform spatial division. The simplification is carried out using each cell as one unit.

If the curvature value of the representative of any node in the curvature tree is larger than an arbitrary curvature value predetermined by a user, the node becomes an object node for simplification, i.e. a node which is subject to simplification. The object node for simplification is searched using a bottom-up method in which search is made from lower nodes of the curvature tree toward higher nodes.

When any object node for simplification is found via the foregoing method, an edge or edges in the node is contracted. If there are at least two edges, the order of edges to be contracted is determined using a concept of compactness. Unless the edges violate geometry, edge contraction is executed. The compactness is considered as the aspect ratio of faces.

Also, if the faces produced after the edge contraction have variation in orientation, those edges are not compacted.

The simplification process of the invention has the following three steps of: searching for object cells for simplification; searching for candidate edges in edges in the cells; and edge contraction.

The simplification process is executed using the curvature tree which is produced via spatial division using the curvatures.

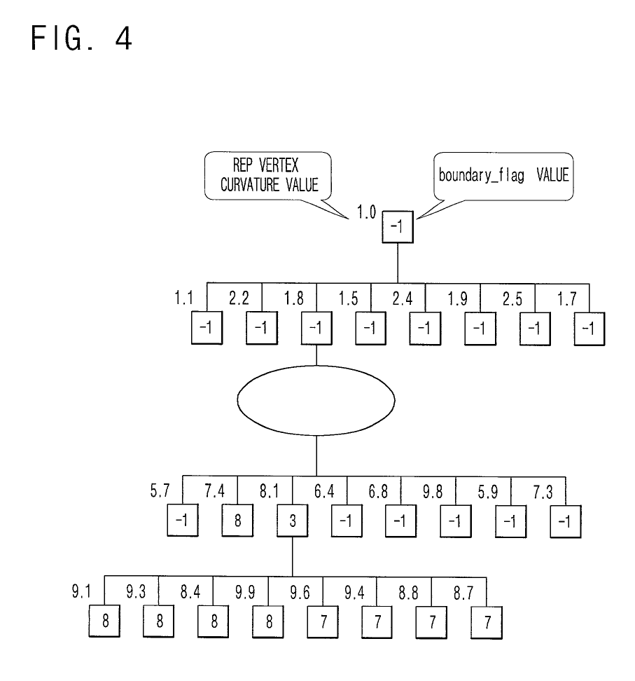

FIG. 4 shows variation of boundary flag values of a curvature tree in a simplification process, in which the value in each node of the curvature tree is the boundary flag value.

The value of boundary flag indicates the number of nodes which are simplified from lower nodes.

As shown in FIG. 4, a node in the second level from the bottom having a value of 3 is simplified from three nodes of a lower cell. This node becomes an object node for simplification with a value of 7, and has a value of 8 if simplification is performed.

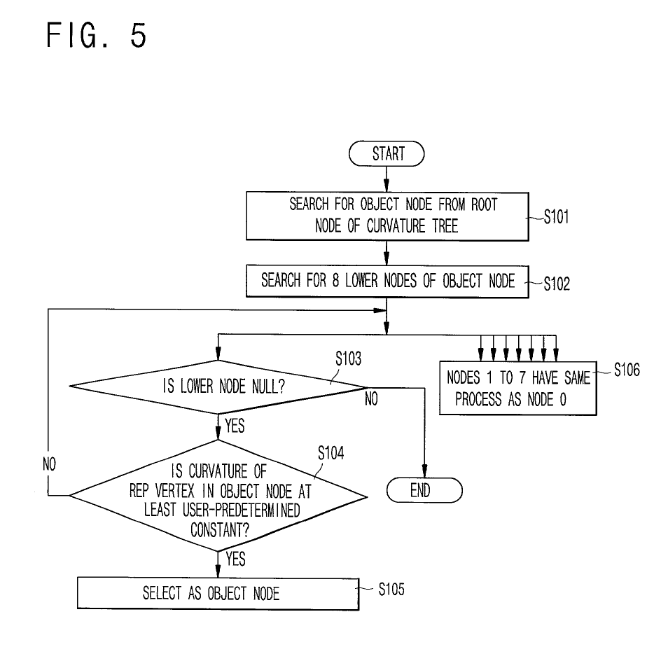

FIG. 5 is a flow chart illustrating a method of searching for object nodes for simplification from nodes in a curvature tree.

As shown in FIG. 5, a curvature value predetermined by a user is compared with the curvature value of the representative vertex of a node, primarily the root node of the curvature tree and later eight lower nodes. If the curvature value of the node is smaller than the predetermined curvature value, comparison is performed to the lower nodes. Otherwise, the lower nodes are considered as object nodes for simplification, i.e. nodes subject to simplification.

Referring to FIG. 5 in more detail, an object node for simplification is primarily searched in the root node of the curvature tree in S101.

In S102, the lower eight nodes of the root node for simplification are searched.

It is judged whether the lowest node in the searched lower nodes, i.e. 0 node, has a null value in S103. If the corresponding lowest node does not have the null value, it is judged whether the curvature value of the representative vertex in the lowest node for simplification has a value at least a constant predetermined by the user in S104.

If the curvature value of the representative vertex in the lowest node has the value at least the constant predetermined by the user, the lowest node is selected as an object node for simplification in S105.

A search process is carried out to the remaining nodes 1 to 7 other than the “0” node in the same manner to select object nodes for simplification, if any.

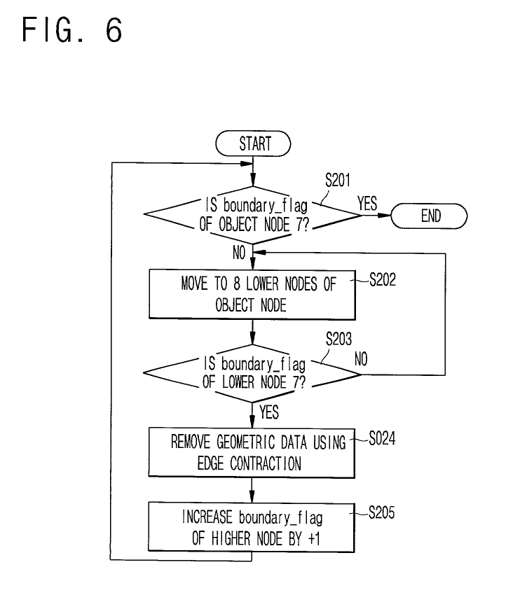

Those object nodes for simplification selected through the foregoing method undergo a simplification method as shown in FIG. 6, in which steps of the simplification method will be described.

FIG. 6 is a flow chart illustrating a method of mesh simplification via ununiform spatial division of the invention.

When the object nodes for simplification are found according to the method shown in FIG. 5, the lowest nodes found from the object nodes are primarily simplified. In the curvature tree, the vertices in the lower nodes have smaller effects to the shape of the meshes than those in the higher nodes. Referring to FIG. 6, the boundary flag of each node is used to find a node having a smaller effect to the mesh shape. Geometric data in the found node are removed using the edge contraction.

Describing in steps, it is primarily judged whether the boundary flag value of the object node for simplification is “7:” in S201.

If it is judged that the boundary flag value of the object node for simplification is not 7, execution moves to lower eight nodes of the object node for simplification in S202.

In S203, it is judged whether each of the lower node has a boundary flag value of 7. If the boundary flag value of the each lower node is 7, the geometric data are removed using the edge contraction in S204.

When the geometric data are removed using the edge contraction, a simplification process is executed in the same manner as set forth above by increasing the boundary flag value of the higher node by +1 in S205.

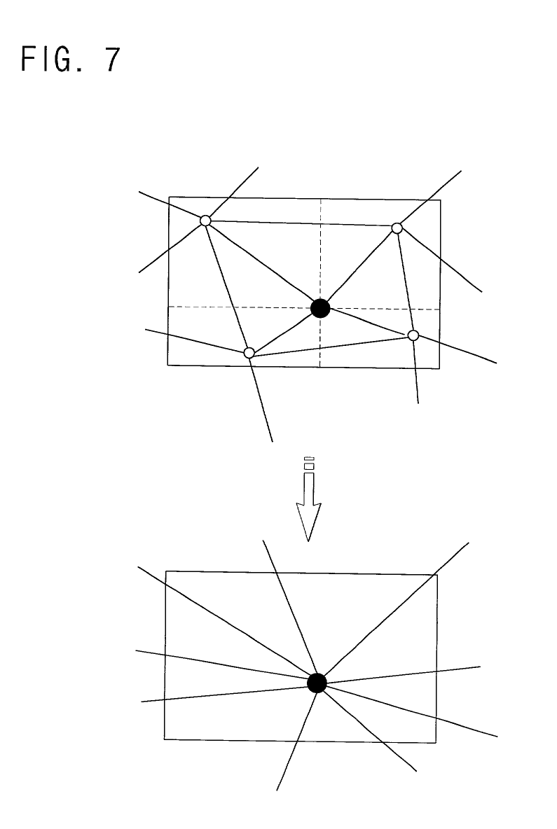

FIG. 7 shows a simplification process via edge contraction in a given node, in which simplification of an arbitrary cell indicates simplification of vertices in lower nodes of the given node.

In FIG. 7, empty circles designate vertices of four cells respectively, and a solid circle designates the representative vertex when the four cells combine into one cell.

In the HDS algorithm of Luebke using a vertex clustering via the spatial division, simplification is not executed as in FIG. 7. Instead, the vertex tree maintains mesh information which is created after simplification using the representative vertex.

However, the vertex tree contains geometrical information of the simplified mesh therein thereby requiring a process for finding the geometrical information. This process is carried out in the spatial division stage so that the pre-treatment stage takes a longer time than a proposal algorithm.

Simplification is executed using a cell as one unit. When a cell to be simplified using the curvature tree is found, edges in the cell are considered as objects for simplification. Any edge found having a smaller effect to the mesh shape is contracted prior to other edges in the cell.

A candidate edge for simplification is selected from edges in a cell determined as an object for simplification, in which a determination process for the candidate edge has the following procedures: aspect ratio test, boundary test, manifold test, orientation test and face angle test.

The first test or aspect ratio test is so purposed that faces after simplification have fine aspect ratios, and carried out using a concept of compactness. The compactness has a value between 0 and 1, in which the value is 1 if all angles of triangle faces are 60° and approaches 0 as any of the angles approaches 0°.

After the faces are compacted, the edges in the object cell for simplification are arranged based upon compactness of the faces connected to the edges to determine the order of the object edges for simplification. After the object edges are ordered based upon compactness, the boundary test is executed. Since simplification of a boundary edge has an effect to the mesh shape, an object edge is not simplified if the edge is at the boundary.

It is confirmed whether non-manifold is produced after simplification, and the manifold test is executed only if the non-manifold is not produced so as to prevent variation of topology. Since the faces produced after the edge contraction tend to have orientation variation, the orientation test is executed in order to avoid the same.

The face angle test is executed as the final test to calculate the angle between the faces produced after the edge contraction. If the angle is beyond the value predetermined by the user, the edge contraction is not executed. Without this test, the angle between the faces tends to gradually increase during simplification, thereby having a great effect to the mesh shape.

This algorithm substantially reduces the geometric data of the mesh using the edge contraction. Using the decimation as a method of reducing geometric data creates a problem of hole triangulation, the hole being produced due to removal of the geometric data. The triangulation is costly, since it should be considered how to execute the triangulation while improving the aspect ratio if the hole is concave or star-shaped. However, the edge contraction does not create such a problem of triangulation.

The edge contraction interconnects two vertices composing an edge, thereby removing two adjacent triangles of the edge to be contracted.

Conventional algorithms using the edge contraction are different in methods of selecting the edges to be contracted. In general, each edge is selected or removed according to the weight applied to the edge. The algorithm of the invention adopts a concept of compactness to apply the weight for selecting an edge to be contracted. The boundary edge is not subjected to the edge contraction because removing the same has a great effect to the mesh shape.

According to the method of mesh simplification via ununiform spatial division of the invention as described hereinbefore, the ununiform spatial division considering the curvatures is employed unlikely from the uniform spatial division used in the vertex clustering so as to allow the simplified mesh to have the initial mesh shape, thereby avoiding the disadvantage of the vertex clustering, i.e. the quality of the simplified meshes degrades. If the space is uniformly divided, in the simplification process, the geometric data having the larger effects to the mesh shape are occasionally removed prior to the geometric data having the smaller effects to the mesh shape. Occasionally, a portion of the meshes having a large curvature is spread flat after simplification, thereby degrading the quality of the simplified meshes. The inventive algorithm divides the space considering the curvatures to primarily remove those portions having the smaller effects to the mesh shape. Those portions of the initial meshes having large curvatures are maintained even after simplification so that the simplified meshes have a similar shape to the initial meshes. Further, the inventive algorithm uses the spatial division and the representative vertices in the simplification process to achieve the high execution rate of the vertex clustering, which is obtained by using the spatial division and the representative vertices.

Therefore, the invention is aimed to achieve the rapid simplification as the advantage of the vertex clustering and avoid the degradation of the simplified meshes as the disadvantage thereof, thereby producing the simplified meshes having high quality while preserving the shape of the initial meshes.

What is claimed is:

1. A method of mesh simplification via ununiform spatial division, the method comprising the following steps of:
calculating curvatures of all vertices composing a mesh;
arranging the vertices in the order of curvature using the calculated curvatures of the vertices to produce a vertex weight list;
producing a curvature tree while dividing a space using the resultant vertex weight list;
searching for a plurality of object cells for simplification in the resultant curvature tree, and searching for candidate edges for simplification having smaller effects to the shape of the mesh from the searched object cells for simplification; and
contracting the searched edges in sequence.

2. A method of mesh simplification via ununiform spatial division according to claim 1, wherein said candidate edge searching step comprises the steps of:
aspect ratio test for determining the order of the edges to be contracted using contraction;
boundary test for judging whether an edge exists in a boundary after said step of aspect ratio test, and selecting the edge as to be contracted if the edge does not exist in the boundary;
manifold test for confirming whether a non-manifold is produced after edge contraction, and selecting the edge as to be contracted only if the non-manifold is not produced;
orientation test for judging whether faces which are produced after edge contraction have variation of orientation, and determining the edge as to be contracted only if there is no variation of orientation; and
calculating the angle between the faces which are produced after edge contraction, and determining the edge as a candidate edge to be contracted if the angle is within a value predetermined by a user.

3. A method of mesh simplification via ununiform spatial division according to claim 1, wherein said contracting step uses an edge contraction in which a plurality of vertices composing the edge are mutually connected.

4. A method of mesh simplification via ununiform spatial division according to claim 1, wherein the vertices of the curvature tree have smaller curvatures in lower nodes.

5. A method of mesh simplification via ununiform spatial division according to claim 1, wherein said calculating step uses a method of curvature calculation by Turk.

6. A method of mesh simplification via ununiform spatial division according to claim 5, wherein said method of curvature calculation by Turk comprises the steps of:
(a) creating a root node of the curvature tree using the first vertex in the curvature weight list as a representative vertex, and producing a plurality of lower nodes on the basis of the position of the representative vertex;
(b) selecting the second vertex in the vertex weight list, and after finding out to which node the second vertex belongs in the lower nodes of the previously created root node, producing lower nodes using the second vertex as the representative vertex; and
repeating the foregoing steps (a) and (b) for all of the remaining vertices.

7. A method of mesh simplification via ununiform spatial division, the method comprising the following steps of:
calculating curvatures of all vertices composing a mesh;
arranging the vertices in the order of curvature using the calculated curvatures of the vertices to produce a vertex weight list;
producing a curvature tree while dividing a space using the produced vertex weight list;
searching for an object node for simplification from a root node of the resultant curvature tree;
searching an arbitrary number of lower nodes in the object node for search;
judging whether a node value is null in the lower nodes, sequentially from the lowest node up to the highest node, and if the node value is null, judging whether a curvature value of a representative vertex in the object node for search is at least a constant value predetermined by a user; and
if the curvature value of the representative vertex in the object node for search is at least constant value predetermined by a user, selecting the object node for search as the object node for simplification.

8. A method of mesh simplification via ununiform spatial division, the method comprising the following steps of:
(a) calculating curvatures of all vertices composing a mesh;
(b) arranging the vertices in the order of curvature using the calculated curvatures of the vertices to produce a vertex weight list;
(c) producing a curvature tree while dividing a space using the produced vertex weight list;
(d) searching a plurality of nodes to be simplified in a root node of the resultant curvature tree, and comparing a curvature value of a representative vertex of each of the searched nodes with a constant predetermined by a user to select an object node for simplification;
(e) extracting a boundary flag value of the object node for simplification, and removing geometric data using an edge contraction method based upon the extracted boundary flag value; and
(f) repeating the foregoing steps (a) to (e) by increasing the flag value of the object node for simplification by +1 to remove the geometric data.
